(19) United States
(12) Patent Application Publication
(10) Pub. No.: US 2022/0351878 A1
(43) Pub. Date: Nov. 3, 2022

(54) TRANSPARENT ELECTRICALLY CONDUCTIVE FILM AND PRODUCING METHOD THEREOF

(71) Applicant: NITTO DENKO CORPORATION, Ibaraki-shi, Osaka (JP)

(72) Inventors: Masanori Matsumoto, Osaka (JP); Hiroshi Beppu, Osaka (JP); Tomohiro Takeyasu, Osaka (JP)

(73) Assignee: NITTO DENKO CORPORATION, Ibaraki-shi, Osaka (JP)

(21) Appl. No.: 17/763,896

(22) PCT Filed: Sep. 17, 2020
(86) PCT No.: PCT/JP2020/035264

§ 371 Date: Mar. 25, 2022

(30) Foreign Application Priority Data
Sep. 25, 2019 (JP) 2019-174238

(51) Int. Cl. H01B 5/14; H01B 13/00

(52) U.S. Cl. CPC H01B 5/14; H01B 13/0016; H01B 13/0036

(57) ABSTRACT

A transparent electrically conductive film includes a transparent substrate, a cured resin layer, and a transparent electrically conductive layer in order. The transparent electrically conductive layer has film density of below 6.85 g/cm³.

### TECHNICAL FIELD

The present invention relates to a transparent electrically conductive film and a producing method thereof, to be specific, to a transparent electrically conductive film preferably used for optical applications, and a method for producing a transparent electrically conductive film.

### BACKGROUND ART

Conventionally, a transparent electrically conductive film in which a transparent electrically conductive layer composed of an indium tin composite oxide (ITO) is formed into a desired electrode pattern is used for optical applications such as touch panels.

As the transparent electrically conductive film, for example, it is proposed that a flexible substrate film, a hard coat layer, and a transparent electrically conductive layer are provided in order (ref: for example, Patent Document 1).

Then, in the transparent electrically conductive film of Patent Document 1, the transparent electrically conductive layer (ITO film) is crystallized by heating treatment at 150° C.

### Citation List

### Patent Document

Patent Document 1: Japanese Unexamined Patent Publication No. 2018-012290

### SUMMARY OF THE INVENTION

### PROBLEM TO BE SOLVED BY THE INVENTION

Accordingly, in the transparent electrically conductive film of Patent Document 1, since the transparent electrically conductive layer (ITO film) is crystallized at high temperature (150° C.), the hard coat layer and the transparent electrically conductive layer are expanded by heating during crystallization (during heating). After the crystallization (after cessation of the heating), the hard coat layer and the transparent electrically conductive layer which are expanded shrink.

Such a transparent electrically conductive film does not cause visibility problems under normal temperature conditions (for example, around 20° C.), but when the transparent electrically conductive film is under humidification conditions for example, 65° C., relative humidity of 95%), only the hard coat layer greatly shrinks. Therefore, a fine waviness-like pattern of a micrometer order is produced on the surface of the film after being subjected to the humidification conditions. Thus, there is a problem that irregular shininess is produced on the surface of the film and the visibility decreases.

The present invention provides a transparent electrically conductive film having excellent humidification reliability and a method for producing a transparent electrically conductive film.

### MEANS FOR SOLVING THE PROBLEM

The present invention [1] includes a transparent electrically conductive film including a transparent substrate, a cured resin layer, and a transparent electrically conductive layer in order, wherein the transparent electrically conductive layer has film density of below 6.85 g/cm ³.

The present invention [2] includes the transparent electrically conductive film described in the above-described [1] wherein the transparent substrate has a thickness of below 50 μm.

The present invention [3] includes the transparent electrically conductive film described in the above-described [1] or [2], wherein the transparent electrically conductive layer is crystalline.

The present invention [4] includes a method for producing a transparent electrically conductive film including a first step of preparing a transparent substrate, a second step of laminating a cured resin layer on the upper surface of the transparent substrate, and a third step of laminating a transparent electrically conductive layer on the upper surface of the cured resin layer, wherein in the third step, the transparent electrically conductive layer is crystallized by leaving the transparent electrically conductive layer to Amid at 20° C. or more and 30° C. or less, or by heating the transparent electrically conductive layer at below 60° C. , and the transparent electrically conductive layer has film density of below 6.85 g/cm³.

### EFFECT OF THE INVENTION

The transparent electrically conductive film of the present invention includes a transparent substrate, a cured resin layer, and a transparent electrically conductive layer in order, and the transparent electrically conductive layer has film density of below 6.85 g/cm³.

Thus, it is possible to suppress shrinkage of the cured resin layer under humidification conditions, and suppress a decrease in visibility. As result, humidification reliability is excellent.

The method for producing a transparent electrically conductive film of the present invention crystallizes a transparent electrically conductive layer so that the film density decreases by leaving the transparent electrically conductive layer to stand at 20° C. or more and 30° C. or less, or by heating the transparent electrically conductive layer at below 60° C.

Thus, it is possible to suppress the shrinkage of the cured resin layer under the humidification conditions, and suppress a decrease in the visibility. As a result, the humidification reliability is excellent.

### BRIEF DESCRIPTION OF THE DRAWINGS

FIG. 1 shows a cross-sectional view of a transparent electrically conductive film of the present invention.

### DESCRIPTION OF EMBODIMENTS

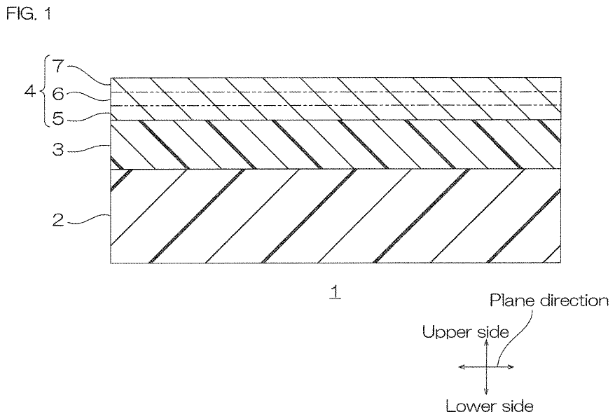

One embodiment of a transparent electrically conductive film of the present invention is described with reference to FIG. 1.

In FIG. 1, the up-down direction on the plane of the sheet is an up-down direction (thickness direction), the upper side on the plane of the sheet is an upper side (one side in the thickness direction), and a lower side on the plane of the sheet is a lower side (the other side in the thickness direction). The right-left direction and the depth direction on the plane of the sheet are a plane direction perpendicular to the up-down direction. Specifically, directions are in conformity with direction arrows in each view.

### 1. Transparent Electrically Conductive Film

A transparent electrically conductive film 1 has a film shape (including a street shape) having a predetermined thickness, extends in a predetermined direction (plane direction) perpendicular to the thickness direction, and has a flat upper surface and a flat lower surface. The transparent electrically conductive film 1 is, for example, one component of a substrate for a touch panel and an electromagnetic wave shield provided in an image display device, that is, not the image display device. That is, the transparent electrically conductive film 1 is a component for fabricating an image display device and the like, and does not include an image display element such as an OLED module. The transparent electrically conductive film 1 includes a transparent substrate 2, a cured resin layer 3, and a transparent electrically conductive layer 4, and is an industrially available device whose component alone is distributed.

Specifically, as shown in FIG. 1, the transparent electrically conductive film 1 includes the transparent substrate 2, the cured resin layer 3 disposed on the upper surface (one surface in the thickness direction) of the transparent substrate 2, and the transparent electrically conductive layer 4 disposed on the upper surface of the cured resin layer 3. More specifically, the transparent electrically conductive film 1 includes the transparent substrate 2, the cured resin layer 3, and the transparent electrically conductive layer 4 in order. The transparent electrically conductive film 1 preferably consists of the transparent substrate 2, the cured resin layer 3, and the transparent electrically conductive layer 4.

### 2. Transparent Substrate

The transparent substrate 2 is a transparent substrate for ensuring mechanical strength of the transparent electrically conductive film 1. That is, the transparent substrate 2 supports the transparent electrically conductive layer 4 together with the cured resin layer 3.

The transparent substrate 2 is the lowermost layer of the transparent electrically conductive film 1 and has a film shape. The transparent substrate 2 is disposed on the entire lower surface of the cured resin layer 3 so as to be in contact with the lower surface of the cured resin layer 3.

The transparent substrate 2 is, for example, a polymer film having transparency. Examples of a material for the transparent substrate 2 include olefin resins such as polyethylene, polypropylene, and cycloolefin polymer; polyester resins such as polyethylene terephthalate (PET), polybutylene terephthalate, and polyethylene naphthalate; (meth)acrylic resins (acrylic resins and/or methacrylic resins) such as polymethacrylate; polycarbonate resins; polyether sulfone resins; polyarylate resins; melamine resins; polyamide resins; polyimide resins; cellulose resins; and polystyrene resins. These transparent substrates 2 may he used alone or in combination of two or more.

Preferably, an amorphous thermoplastic resin is used. Thus, a desired polarization axis may be obtained. Transparency is also excellent.

As the amorphous thermoplastic resin, preferably, a cycloolefin polymer is used. That is, the transparent substrate 2 is preferably a cycloolefin-based film formed of the cycloolefin polymer.

The cycloolefin-based polymer is a polymer obtained by polymerizing a cycloolefin monomer and haying an alicyclic structure in a repeating unit of a main chain. The cycloolefin-based resin is preferably an amorphous cycloolefin-based resin.

Examples of the cycloolefin-based polymer include a cycloolefin homopolymer consisting of a cycloolefin monomer, and a cycloolefin copolymer consisting of a copolymer of a cycloolefin monomer and an olefin such as ethylene.

Examples of the cycloolefin monomer include polycyclic olefins such as norbornene, methylnorbornene, dimethylnorbornene, ethylidene norbornene, butylnorbornene, dicyclopentadiene, dihydrodicyclopentadiene, tetracyclododecene, and tricyclopentadiene; and. monocyclic olefins such as cyclobutene, cyclopentene, cyclooctadiene, and cyclooctatriene. Preferably, a polycyclic olefin is used. These cycloolefins may be used alone or in combination of two or more.

The transparent substrate 2 has a total tight transmittance (JIS K 7375-2008) of, for example, 80% or more, preferably 85% or more.

From the viewpoint of mechanical strength and the like, the transparent substrate 2 has a thickness of, for example, 2 μm or more, preferably 20 μm or more, and for example, 300 μm or less, preferably 150 μm or less, and from the viewpoint of flexibility, it has a thickness of more preferably below 50 μm. The thickness of the transparent substrate 2 may be, for example, measured using a microgauge-type thickness meter.

### 3. Cured Resin Layer

The cured resin layer 3 is a protective layer for suppressing occurrence of a scratch on the transparent substrate 2 when the transparent electrically conductive film 1 is produced. Further, it is a scratch resistant layer for suppressing the occurrence of the scratch on the transparent electrically conductive layer 4 when the plurality of transparent electrically conductive films 1 are laminated.

The cured resin layer 3 has a film shape. The cured resin layer 3 is disposed on the entire upper surface of the transparent substrate 2 so as to be in contact with the upper surface of the transparent substrate 2. More specifically, the cured resin layer 3 is disposed between the transparent substrate 2 and the transparent electrically conductive layer 4 so as to be in contact with the upper surface of the transparent substrate 2 and the lower surface of the transparent electrically conductive layer 4.

The cured resin layer 3 is formed of a curable resin composition. The curable resin composition contains a curable resin.

Examples of the curable resin include an active energy ray curable resin which is cured by irradiation by active energy rays (specifically, ultraviolet rays, electron beams, and the like) and a thermosetting resin which is cured by heating, and preferably, an active energy ray unable resin is used.

An example of the active energy ray curable resin includes a polymer having a functional group haying a polymerizable carbon-carbon double bond in a molecule. Examples of the functional group include vinyl groups and (meth)acryloyl groups (methacryloyl groups and/or acryloyl groups).

Specific examples of the active energy ray curable resin include (meth)acrylic ultraviolet curable resins such as urethane acrylate and epoxy acrylate.

Further, examples of the curable resin other than the active energy ray curable resin include urethane resins, melamine resins, alkyd resins, siloxane-based polymers, and organic silane condensates.

These resins may be used alone or in combination of two or more.

The curable resin composition may also contain particles. Thus, the cured resin layer 3 may be used as an anti-blocking layer having anti-blocking properties.

Examples of the particles include organic particles and inorganic particles. Examples of the organic particles include cross-linking acrylic particles such as cross-linking acrylic-styrene resin particles. Examples of the inorganic particles include silica particles; metal oxide particles consisting of zirconium oxide, titanium oxide, zinc oxide, tin oxide, and the like; and carbonate particles such as calcium carbonate. These particles may be used alone or in combination of two or more.

Preferably, the curable resin composition does not contain the particles and contains the curable resin.

The curable resin composition may furthermore contain a known additive such as a leveling agent, a thixotropic agent, and an antistatic agent.

The cured resin layer 3 has a thickness of, for example, 0.1 μm or more, preferably 0.5 μm or more, and for example, 10 μm or less, preferably 3 μm or less from the viewpoint of scratch resistance. The thickness of the cured resin layer 3 can be, for example, calculated based on a wavelength of an interference spectrum observed using an instantaneous multi-photometric system (for example, manufactured by OTSUKA ELECTRONICS CO., LTD., “MCPD2000”).

### 4. Transparent Electrically Conductive Layer

The transparent electrically conductive layer 4 is a transparent layer which is crystalline and develops excellent electrical conductivity.

The transparent electrically conductive layer 4 is the uppermost layer of the transparent electrically conductive film 1 and has a film shape. The transparent electrically conductive layer 4 is disposed on the entire upper surface of the cured resin layer 3 so as to be in contact with the upper surface of the cured resin layer 3.

The transparent electrically conductive layer 4 has a Su region 5, a Sn/Hf mixed region 6, and a Hf region 7 in order from the lower side.

Since the transparent electrically conductive layer 4 has the Hf region 7 and the Sn region 5 in the thickness direction, it is possible to achieve both an excellent crystallization rate and excellent electrical conductivity. That is, though the details are described later, the transparent electrically conductive film 1 develops excellent electrical conductivity, while capable of crystallizing the transparent electrically conductive layer 4 at low temperature in a short time.

The Sn region 5 is a lower layer formed so as to extend in the plane direction on the upper surface of the cured resin layer 3. The Sn region 5 is formed of an indium-based oxide containing tin (Sn), and is preferably fanned of an indium tin composite oxide (ITO).

In the Sn region 5, the tin oxide (SnO₂) content is, for example, 0.5% by mass or more, preferably 3% by mass or more, and for example, 15% by mass or less, preferably 13% by mass or less with respect to the total amount of the tin oxide and the indium oxide (In₂O₃). When the tin oxide content is the above-described lower limit or more, it is possible to improve the crystallization rate of the transparent electrically conductive layer 4. When the tin oxide content is the above-described upper limit or less, it is possible to improve the electrical conductivity of the transparent electrically conductive layer 4.

The Sn region 5 may also contain inevitable impurities as a metal other than Sn and In.

Also, the Sn region 5 substantially does not contain Hf. That is, in the Sn region 5, a Hf element is not detected in the measurement by an X-ray photoelectron spectroscopy.

The Sn region 5 has a thickness of, for example, 1 nm or more, preferably 3 nm or more, preferably 10 nm or more, and for example, 50 nm or less, preferably 40 nm or less, more preferably 30 nm or less. The thickness of each region can be determined by measuring the transparent electrically conductive layer 4 in the thickness direction by the X-ray photoelectron spectroscopy.

The Sn/Hf mixed region 6 is an intermediate layer formed so as to extend in the plane direction on the upper side of the Sn region 5. In the Sn/Hf mixed region 6, both elements contained in the Sn region 5 and those contained in the Hf region 7 are mixed. Specifically, the Sn/Hf mixed region 6 is formed of an oxide containing Sn, Hf, and In. In addition, the Sn/Hf mixed region 6 may contain Ta (tantalum), and in this case, it is formed of an oxide containing Sn, Hf, Ta, and In.

Preferably, the Sn/Hf mixed region 6 is a region which gradually changes from the Sn region 5 to the Hf region 7. That is, a content ratio of the SN element gradually decreases and a content ratio of the Hf element gradually increases from the lower end toward the upper end of the Sn/Hf mixed region 6. In other words, a cross section of the transparent electrically conductive layer 4 does not have an interface. That is, the transparent electrically conductive layer 4 does not have both the Sn region-Sn/Hf mixed region interface (6/7 interface) and the Sn/Hf mixed region-Hf region interface (7/8 interface).

The Sn/Hf mixed region 6 has a thickness of, for example, 1 nm or more, preferably 2 nm or more, more preferably 3 nm or more, and for example, 10 nm or less, preferably 8 nm or less, more preferably 6 nm or less.

The Hf-region 7 is an upper layer formed so as to extend in the plane direction on the upper side of the Sn/Hf mixed region 6. The Hf region 7 is formed of an indium-based oxide containing hafnium (Hf), and is preferably formed of an oxide containing Hf, Ta (tantalum), and In.

When Ta is not contained, a content ratio (atom ratio) of Hf, as Hf/(Hf+In), is, for example, 0.2 at % or more, preferably 0.5 at % or more, and for example, 3.0 at % or less, preferably 2.5 at % or less.

When Ta is contained, a content ratio (atom ratio) of Hf, as Hf/(Hf+Ta+IN), is for example, 0.2 at % or more, preferably 0.5 at % or more, and for example, 3.0 at % or less, preferably 2.5 at % or less.

A content ratio (atom ratio) of Ta, as Ta/(Hf+Ta+In), is, for example, 0.02 at % or more, preferably 0.1 at % or more, and for example, 1.3 at % or less, preferably 1.0 at % or less.

A content ratio (atom ratio) of In, as In/(Hf+In) or In/(Hf+Ta+In), is, for example, 95.0 at % or more, preferably 97.0 at % or more, and for example, 99.7 at % or less, preferably 99.0 at % or less.

The Hf region 7 may contain inevitable impurities as a metal other than Hf, Ta, and In.

Further, the Hf region 7 substantially does not contain Sn. That is, in the Hf region 7, a Sn element is not detected in the measurement by the X-ray photoelectron spectroscopy.

The Hf region 7 has a thickness of, for example, 1 nm or more, preferably 3 nm or more, preferably 8 nm or more, and for example, 50 nm or less, preferably 40 nm or less, more preferably 30 nm or less.

The thickness of the Hf region 7 is preferably thicker than that of the Sn region 5. Thus, the crystallization rate at low temperature is furthermore excellent.

The surface resistivity of the upper surface of the transparent electrically conductive layer 4 is, for example, 100 Ω/□ or less, preferably 80 Ω/□ or less, and for example, 10 Ω/□ or more. The surface resistivity may be measured by a four-terminal method.

The specific resistance of the upper surface of the transparent electrically conductive layer 4 is, for example, 3.0×10⁻⁴Ω·cm or less, preferably 2.5×10⁻⁴Ω·cm or less, and for example, 1.0×10⁻⁴Ω·cm or more. The specific resistance may be measured by the four-terminal method.

The entire transparent electrically conductive layer 4 has a thickness of, far example, 5 nm. or more, preferably 10 nm or more, and, for example, 80 nm or less, preferably 35 nm or less. By setting the thickness of the transparent electrically conductive layer 4 within the above-described range, it is possible to more reliably achieve both the crystallization rate at low temperature and the electrical conductivity. The thickness of the entire transparent electrically conductive layer 4 can be, for example, measured by observing a cross section of the transparent electrically conductive film 1 using a transmission-type electron microscope.

The transparent electrically conductive layer 4 is crystalline.

When the transparent electrically conductive layer 4 is crystalline, the above-described surface resistivity may be lowered.

The crystallinity of the transparent electrically conductive layer 4 may be, for example, judged by immersing, the transparent electrically conductive film 1 in a hydrochloric acid (20° C., concentration of 5% by mass) for 15 minutes to be subsequently washed and dried, and thereafter, measuring interterminal resistance between about 15 mm with respect to the surface of the transparent electrically conductive layer 4-side. In the transparent electrically conductive film 1 after immersion, water washing, and drying described above, when the interterminal resistance between 15 mm is 10 kΩ or less, the transparent electrically conductive layer 4 is crystalline, and when the above-described resistance is above 10 kΩ the transparent electrically conductive layer 4 is amorphous.

### 5. Method or Producing Transparent Electrically Conductive Film

A method for producing the transparent electrically conductive film 1 is described. The method for producing the transparent electrically conductive film 1 includes a first step of preparing the transparent substrate 2, a second step of laminating the cured resin layer 3 on the upper surface of the transparent substrate 2, and a third step of laminating the transparent electrically conductive layer 4 on the upper surface of the cured resin layer 3.

First, in the first step, a known or commercially available transparent substrate 2 is prepared. Preferably, a cycloolefin-based film is prepared.

Thereafter, if necessary, from the viewpoint of adhesive properties of the transparent substrate 2 with the cured resin layer 3, the upper surface of the transparent substrate 2 may be, for example, subjected to etching treatment and primer treatment such as sputtering, corona discharging, flame, ultraviolet irradiation, electron beam irradiation, chemical conversion, and oxidation. Further, it is possible to remove dust from the transparent substrate 2 and cleanse it by solvent cleansing, ultrasonic cleansing, and the like.

Them in the second step, the cured resin layer 3 is laminated on the upper surface of the transparent substrate 2. For example, by wet coating a curable resin composition on the upper surface of the transparent substrate 2, the cured resin layer 3 is formed on the upper surface of the transparent substrate 2.

Specifically, for example, a solution (varnish) obtained by diluting the curable resin composition with a solvent is prepared, and subsequently, a curable resin composition solution is applied to the upper surface of the transparent substrate 2 to be dried.

Examples of the solvent include an organic solvent and an aqueous solvent (specifically, water), and preferably, an organic solvent is used. Examples of the organic solvent include alcohol compounds such as methanol, ethanol, and isopropyl alcohol; ketone compounds such as acetone, methyl ethyl ketone, and methyl isobutyl ketone; ester compounds such as ethyl acetate and butyl acetate; ether compounds such as propylene glycol monomethyl ether; and aromatic compounds such as toluene and xylene. These solvents may be used alone or in combination of two or more.

The solid content concentration in the curable resin composition solution is, for example, 1% by mass or more, preferably 10% by mass or more, and for example, 30% by mass or preferably 20% by mass or less.

An application method may be appropriately selected in accordance with the curable resin composition solution and the transparent substrate 2. Examples of the application method include a dip coating method, an air knife coating method, a curtain coating method, a roller coating method, a wire bar coating method, a gravure coating method, and an extrusion coating method.

A drying temperature is, for example, 50° C. or more, preferably 70° C. or more, and far example. 150° C. or less, preferably 100° C. or less.

The drying time is, for example, 0.5 minutes or more, preferably 1 minute or more, and for example, 60 minutes or less, preferably 20 minutes or less.

Thereafter, when the curable resin composition contains the active energy ray curable resin, the active energy ray curable resin is cured by irradiating an active energy ray after drying the curable resin composition solution.

When the curable resin composition contains a thermosetting resin, the thermosetting resin can be thermally cured along with drying of the solvent in the drying step.

Next, in the third step, the transparent electrically conductive layer 4 is laminated on the upper surface of the cured resin layer 3. For example, the transparent electrically conductive layer 4 is formed on the upper surface of the cured resin layer 3 by a drying method.

In the formation of the transparent electrically conductive layer 4, the Sn region 5 and the Hf region 7 are formed in order. Preferably, the Sn region 5 and the Hf region 7 are continuously formed by the same drying method. Thus, components are mixed on the interface between the Sn region 5 and the Hf region 7 to form the Sn/Hf mixed region 6.

Examples of the drying method include a vacuum deposition method, a sputtering method, and an ion plating method. Preferably, a sputtering method is used. By this method, a desired transparent electrically conductive layer 4 can be formed.

Examples of the sputtering method include a dipole sputtering method, an ECR (electron cyclotron resonance) sputtering method, a magnetron sputtering method, and an ion beam sputtering method. Preferably, a magnetron sputtering method is used.

An example of a target material in the formation of the Sn region 5 includes an indium-based oxide containing Sn. Preferably, ITO (In-Sn-containing oxide) is used.

In the formation of the Sn region 5, an example of the sputtering gas includes an inert gas such as Ar. Further, if necessary, a reactive gas such as an oxygen gas may be used in combination. When the reactive gas is used in combination, a flow ratio of the reactive gas is, for example, 0.1 flow % or more and 5 flow % or less with respect to the total flow ratio of the sputtering gas and the reactive gas.

The sputtering method is carried out under vacuum. Specifically, an atmospheric pressure during sputtering is, for example, 1 Pa or less, preferably 0.7 Pa or less from the viewpoint of suppression of a decrease in a sputtering rate, and discharge stability.

A power source used in the sputtering method may be any of, for example, a DC power source, an AC power source, an MF power source, and an RF power source, and may be a combination of these.

A sputtering device has a set thickness (target value) of, for example, 5 nm or more, preferably 10 nm or more, more preferably 12 nm or more, and for example, 50 nm or less, preferably 30 nm or less, more preferably 20 nm or less.

In the formation of the Hf region 7, an example of target material includes an indium-based oxide containing Hf. Preferably, an oxide containing In, Hf, and Ta (In-Hf-Ta-containing oxide) is used. Specific examples of the target material include oxide sintered compacts described in Japanese Unexamined Patent Publications No. H10-269843, 2017-149636, and 2018-188677.

The sputtering device has the set thickness of for example, 5 nm or more, preferably 10 nm or more, more preferably 15 nm or more, and for example, 50 nm or less, preferably 30 nm or less, more preferably 25 nm or less.

In the formation of the Hf region 7, as the conditions of the sputtering method, the same conditions as those of the formation of the Sn region 5 are used except for the description above.

In order to form the transparent electrically conductive layer 4 having a desired thickness, the sputtering may be carried out a plurality of times by appropriately setting the conditions of the target material and the sputtering.

Thus, an amorphous transparent electrically conductive film including the transparent substrate 2, the cured resin layer 3, and the amorphous transparent electrically conductive layer 4 in order is obtained.

Next, in the third step, the transparent electrically conductive layer 4 is crystallized by being left to stand or heating at a predetermined temperature.

To crystallize the transparent electrically conductive layer 4 by being left to stand, specifically, the amorphous transparent electrically conductive film is left to stand in the atmosphere under the conditions of 20° C. or more and 30° C. or less, for example, 24 hours or more and 480 hours or less.

When the temperature at the time of being left to stand is the above-described upper limit or less, it is possible to lower film density (described later) of the transparent electrically conductive layer 4.

When the temperature at the time of being left to stand is the above-described lower limit or mote, it is possible to reliably crystallize the transparent electrically conductive layer 4.

Also, When the time at the time of being left to stand is within the above-described range, it is possible to reliably crystallize the transparent electrically conductive layer 4.

In addition, to crystallize the transparent electrically conductive: layer 4 by heating, the amorphous transparent electrically conductive film is heated under the atmosphere.

The heating may be, for example, carried out using an infrared heater, an oven, and the like.

A heating temperature is below 60° C. , preferably 40° C. or less, and for example, 25° C. or more.

When the heating temperature is the above-described upper limit or less, it is possible to lower the film density (described later) of the transparent electrically conductive layer 4.

When the heating temperature is the above-described lower limit or more, it is possible to reliably crystallize the transparent electrically conductive layer 4.

The heating time is, for example, one minute or more, preferably 10 minutes or more, and for example, 60 minutes or less, preferably 30 minutes or less.

When the heating time is the above-described lower limit or more, it is possible to reliably crystallize the transparent electrically conductive layer 4. On the other hand, when the heating time is the above-described upper limit or less, production efficiency is excellent.

Thus, the transparent electrically conductive layer 4 is crystallized, and as shown in FIG. 1, the transparent electrically conductive film 1 including the transparent substrate 2, the cured resin layer 3, and the transparent electrically conductive layer 4 in order is obtained. The transparent electrically conductive layer 4 is crystalline and includes the Sn region 5, the Sn/Hf mixed region 6, and the Hf region 7 in order from the lower side.

In the above-described production method, the cured resin layer 3 and the transparent electrically conductive layer 4 may be formed in the transparent substrate 2 during conveyance of the transparent substrate 2 by a roll-to-roll method. Or, a portion or all of these layers may be formed by a batch method (single wafer processing). From the viewpoint of productivity, preferably, each layer is formed in the transparent substrate 2 during the conveyance of the transparent substrate 2 by the roll-to-roll method.

The resulting transparent electrically conductive film 1 has a thickness of, for example, 2 μm or more, preferably 20 μm or more, and for example, 100 μm or less, preferably 50 μm or less.

Also, in the transparent electrically conductive film 1, the transparent electrically conductive layer 4 has the film density of below 6.85 g/cm³, preferably 6.80 g/cm^{'}or less, more preferably 6.75 g/cm³ or less, further more preferably 6.71 g/cm³ or less.

When the film density of the transparent electrically conductive layer 4 is the above-described upper limit or less, humidification reliability is excellent.

Specifically, for example, as in Patent Document 1, when the transparent electrically conductive layer 4 is crystallized at high temperature (150° C.), the cured resin layer 3 and the transparent electrically conductive layer 4 are expanded by heating during crystallization (during heating). After the crystallization (after cessation of the heating), the cured resin layer 3 and the transparent electrically conductive layer 4 which are expanded shrink.

Then, the transparent electrically conductive film 1 does not cause visibility problems under normal temperature conditions (for example, around 20° C.), but when the transparent electrically conductive film 1 is under humidification conditions (for example, 60° C. or more and 70° C. or less, relative humidity of 80% or more and 90% or less), the cured resin layer 3 greatly shrinks. Therefore, a fine waviness-like pattern of a micrometer order is produced on the surface of the transparent electrically conductive film 1 after being subjected to the humidification conditions. Thus, there is a problem that irregular shininess is produced on the surface of the transparent electrically conductive film 1 and the visibility decreases.

On the other hand, in the above-described method for producing the transparent electrically conductive film 1, the transparent electrically conductive layer 4 is crystallized so that the film density of the transparent electrically conductive layer 4 decreases, to be specific, the film density is below 6.85 g/cm³ by leaving the transparent electrically conductive layer 4 to stand at low temperature (20° C. or more and 30° C. or less) or by heating the transparent electrically conductive layer 4 at low temperature (below 60° C).

Thus, it is possible to suppress shrinkage of the cured resin layer 3 under the above-described humidification conditions, and suppress a decrease in the visibility. That is, the humidification reliability is excellent.

The above-described film density can be measured by an X-ray reflectance method in conformity with the conditions of Examples to be described later.

The transparent electrically conductive film 1 is, for example, provided in an optical device. An example of the optical device includes an image display device. When the transparent electrically conductive film 1 is provided in the image display device (specifically, an image display device having an image display element such as an OLED module and an LCD module), the transparent electrically conductive film 1 is patterned, if necessary, and used as, for example, an electromagnetic wave shield, a substrate for a touch panel, and the like. When the transparent electrically conductive film 1 is used as the substrate for a touch panel, examples of a system of the touch panel include various systems such as an optical system, an ultrasonic system, an electrostatic capacitive system, and a resistive film system, and it is preferably used for a touch panel of an electrostatic capacitive system.

### 6. Modified Examples

In the above-described description, the transparent electrically conductive layer 4 includes the Sn/Hf mixed region 6 disposed between the Sn region 5 and the Hf region 7. Alternatively, it may also not include the Sn/Hf mixed region 6.

In the above-described description, the transparent electrically conductive layer 4 includes the Sn region 5, the Sn/Hf mixed region 6, and the Hf region 7 in order from the lower side. Alternatively, the transparent electrically conductive layer 4 may also include the Hf region 7, the Sn/Hf mixed region 6, and the Sn region 5 in order from the lower side, and the transparent electrically conductive layer 4 may also include the Hf region 7, the Sn/Hf mixed region 6, the Sn region 5, the Sn/Hf mixed region 6, and the Hf region 7 in order from the lower side.

Also, in the above-described description, the transparent electrically conductive layer 4 has a multi-layer structure including the Sn region 5, the Sn/Hf mixed region 6, and the Hf region 7. However, the structure thereof is not limited to this, and a single layer structure may be also used.

When the transparent electrically conductive layer 4 has a single-layer structure, the transparent electrically conductive layer 4 is, for example, formed of a material such as a metal oxide containing at least one kind of metal selected from the group consisting of In, Sn, Zn, Ga, Sb, Ti, Si, Zr, Mg, Al, Au, Ag, Cu, Pd, and W.

The transparent electrically conductive layer 4 is preferably formed of an indium-containing oxide such as an indium tin composite oxide (ITO).

### EXAMPLES

Next, the present invention is further described based on Examples and Comparative Examples below. The present invention is however not limited by Examples and Comparative Examples. The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”.

### 1. Production of Transparent Electrically Conductive Film

### Example 1

As a transparent substrate, a cycloolefin-based film (thickness of 22 μm, manufactured by ZEON CORPORATION. “ZeonorFilm”) was prepared.

A curable resin composition solution containing an ultraviolet curable acrylic resin was applied onto the upper surface of a transparent substrate to be dried. Thereafter, a curable resin composition was cured by ultraviolet ray irradiation. Thus, a cured resin layer having a thickness of 1.0 μm was formed.

Then, a transparent electrically conductive layer was formed on the upper surface of the cured resin layer.

Specifically, by a DC sputtering method, an ITO sintered compact (containing 90 wt % of indium oxide and 10 wt % of tin oxide) was sputtered by adjusting a set thickness of a sputtering output to 21 nm. As the vacuum conditions, 98% of argon gas and 2% of oxygen gas were introduced with an atmospheric pressure of 0.4 Pa. Thus, an amorphous ITO layer having a thickness of 24 μm was formed.

Then, the set thickness of the sputtering output was adjusted to 5 nm on the upper surface of the ITO layer to sputter the ITO sintered compact (containing 96.7 wt % of indium oxide and 3.3 wt % of tin oxide). As the vacuum conditions, 98% of argon gas and 2% of oxygen gas were introduced with an atmospheric pressure of 0.4 Pa. Thus, an amorphous ITO layer having a thickness of 5 nm was formed.

Thereafter, by a DC sputtering method, the set thickness of the sputtering output was adjusted to 10 nm on the upper surface of the ITO layer to sputter an In-Hf-Ta-containing oxide sintered compact (manufactured by TOSOH CORPORATION, trade name “USR”). As the vacuum conditions, 98% of argon gas and 2% of oxygen gas were introduced with an atmospheric pressure of 0.4 Pa. Thus, an amorphous In-Hf-Ta-containing oxide layer having a thickness of 5 μm was formed.

Thus, an amorphous transparent electrically conductive layer was formed on the upper surface of the cured resin layer to obtain an amorphous transparent electrically conductive film.

Next, the amorphous transparent electrically conductive film was left to stand under the atmosphere at 25° C. for 480 hours, and the transparent electrically conductive layer was crystallized.

In this manner, the transparent electrically conductive film was obtained.

### Example 2

A transparent electrically conductive film was obtained in the same manner as in Example 1. except that the amorphous transparent electrically conductive film was heated under the atmosphere at 40° C. for 24 hours, and the transparent electrically conductive layer was crystallized.

### Comparative Example 1

A transparent electrically conductive film was obtained in the same manner as in Example 1, except that the amorphous transparent electrically conductive film was heated under the atmosphere at 60° C. for 12 hours, and the transparent electrically conductive layer was crystallized.

### Comparative Example 2

A transparent electrically conductive film was obtained in the same manner as in Example 1, except that the amorphous transparent electrically conductive film was heated under the atmosphere at 95° C. for one hour, and the transparent electrically conductive layer was crystallized.

### 2. Evaluation

### (Film Density)

For each of the transparent electrically conductive films of Examples and Comparative Examples, the film density was measured by an X-ray reflectance method.

The measurement conditions of the X-ray reflectance are shown below:

Measurement Conditions:

Device: manufactured by Rigaku Corporation, “SmartLab”

Measurement time: 25 min

Incidence slit: 0.050 mm

Light receiving slit 1: 0.050 mm

Light receiving slit 2: 0.100 mm

Measurement range: 0 to 2.5°

Step: 0.008°

Speed: 0.100°/min

### (Haze (Visibility))

Haze (referred to as haze (initial period)) was measured for each of the transparent electrically conductive films of Examples and Comparative Examples.

Then, each of the transparent electrically conductive films of Examples and Comparative Examples was left to stand under humidification conditions (65°C., relative humidity of 90%), and then, the haze (referred to as haze (humidification)) was measured again.

The results are shown in Table 1.

Further,isibility was evaluated by a charge rate of haze ((haze (humidification)- haze (initial period)/haze (humidification))×100).

Good: presence of visibility (change rate of haze of below 25%)

Bad: absence of visibility (change rate of haze of 25% or more)

The measurement conditions for haze measurement are shown below.

Device: direct reading haze meter HGM-2DP) (for C light source) (manufactured by Sup Test Instruments Co., Ltd.)

Light source: halogen lamp 12 V, 50 W

Light receiving properties: 395 to 745 nm

### [Table 1]

TABLE 1

| | | | | Comparative | Comparative |
|---|---|---|---|---|---|
| Ex./Comparative Ex. No. | | Ex. 1 | Ex. 2 | Ex. 1 | Ex. 2 |
| Crystallization | Heating Temperature (° C.) | 25 | 40 | 60 | 95 |
| Conditions | Heating Time (time) | Natural | 24 | 12 | 1 |
| | | Crystallization | | | |
| Evaluation | Film Density (g/cm³) | 6.7 | 6.76 | 6.85 | 7.08 |
| | Haze (Initial Period) | 0.7 | 0.6 | 0.5 | 0.6 |
| | Haze (Humidification) | 0.7 | 0.7 | 0.7 | 1.1 |
| | Change Rate of Haze (%) | 0 | 14.2 | 28.6 | 45.5 |
| | Visibility | Good | Good | Bad | Bad |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The transparent electrically conductive film and the method for producing a transparent electrically conductive film of the present invention are preferably used for optical applications.

1. A transparent electrically conductive film comprising:
a transparent substrate, a cured resin layer, and a transparent electrically conductive layer in order, wherein
the transparent electrically conductive layer has film density of below 6.85 g/cm³,

2. The transparent electrically conductive film according to claim 1, wherein
the transparent substrate has a thickness of below 50 μm.

3. The transparent electrically conductive film according to claim 1, wherein
the transparent electrically conductive layer is crystalline.

4. A method for producing a transparent electrically conductive film comprising:
a first step of preparing a transparent substrate,
a second step of laminating a cured resin layer on the upper surface of the transparent substrate, and
a third step of laminating a transparent electrically conductive layer on the upper surface of the cured resin layer, wherein
in the third step, the transparent electrically conductive layer is crystallized by leaving the transparent electrically conductive layer to stand at 20° C. or more and 30° C. or less, or by heating the transparent electrically conductive layer at below 60° C., and
the transparent electrically conductive layer has film density of below 6.85 g/cm³.
